(19) United States
(12) Patent Application Publication
(10) Pub. No.: US 2018/0042807 A1
(43) Pub. Date: Feb. 15, 2018

(54) METHODS AND DEVICES FOR SELF-MYOFASCIAL THERAPY

(71) Applicant: Rad Innovation LLC, Denver, CO (US)

(72) Inventor: Michael Mallory, Evergreen, CO (US)

(21) Appl. No.: 15/283,653

(22) Filed: Oct. 3, 2016

Related U.S. Application Data
(60) Provisional application No. 62/375,135, filed on Aug. 15, 2016.

(51) Int. Cl. A61H 15/00; A61H 1/00

(52) U.S. Cl. CPC A61H 15/0092; A61H 1/008; A61H 2015/0042

(57) ABSTRACT

Massage tool for self-myofascial therapy. A ball has a hole extending along a chord of the ball. The hole is adapted for receiving a rod having a diameter that is slightly smaller than the diameter of the hole, so as to provide sufficient friction to hold the rod in place when inserted into the hole. The ball has an inner core made of a hard thermoplastic polymer, the inner core surrounding the hole, and the inner core is surrounded by an outer layer made from a softer polymer.

### BACKGROUND

The present invention relates to exercise equipment, and more specifically, to tools allowing a user to self-apply massage to areas of the body, such as back, legs and arms.

Self-myofascial therapy (SMT) techniques are commonly used by athletes and physical therapists to aid in recovery of muscles that are prone to being overactive. Fascia is the collagenous portion of the connective tissue in the muscle that provides support, protection, and shape. The fascia can become restricted due to overuse, trauma, and inactivity. Consequently, inflammation may occur and if it becomes bad enough the connective tissue can thicken, which may result in pain irritation, and additional inflammation.

One common SMT technique involves using a handheld “roller rod,” similar to a long, narrow, rolling pin, which works to increase circulation and helps to relieve tight muscles and prepare them for action. By rolling the rod over various muscle groups, such as gluteal muscles (“glutes”), thighs, back, shoulders, lattisimi dorsi (“lats”) and calves, etc., muscle tension can be massaged away and the overall recovery time can be reduced. Also, it can help correct muscle imbalances and reduce risk of injury and pain. However, many conventional roller rods have too much surface area to be able to allow a user to work deeply and more precisely on specific muscles.

To massage hard to reach areas on the body where roller rods cannot be used, many users employ various types of balls, for example tennis balls, squash balls, and the like. However, these balls are intended for playing sports and not for myofascial therapy, and as a result, they do not work very well for myofascial therapy. Accordingly, there is a need for improved SMT techniques and devices for more precise massage of muscles.

### SUMMARY

According to one aspect of the present invention, devices and methods are provided for self-myofascial therapy. A ball has a hole extending along a chord of the ball. The hole is adapted for receiving a rod having a diameter that is slightly smaller than the diameter of the hole, so as to provide sufficient friction to hold the rod in place when inserted into the hole. The ball has an inner core made of a hard thermoplastic polymer, the inner core surrounding the hole, and an outer layer made from a softer polymer surrounds the inner core.

Various embodiments can include one or more of the following features. The chord can coincide pass through the center of the ball. The softer polymer can be thermoplastic rubber. The softer polymer can have a hardness in the range of approximately 30-35 on the Shore A scale. The inner core can be made up of three pieces of a hard thermoplastic polymer.

The massage tool can further include a rod inserted into the hole of the ball. The rod can protrude on only one side or on both sides of the ball when inserted into the hole. The rod can include a central core surrounded by a sleeve, and the sleeve can be divided into a center section and two distal sections. The distal sections can be handles for holding the rod by a user. The central core can be made from steel. The central core can have a diameter of approximately ⅜ of an inch. The sleeve can be made from Polyvinyl Chloride.

The massage tool can have a coating of silicone on the distal sections of the sleeve. The massage tool can have a coating of Ethylene Vinyl Acetate on the central on the center section of the sleeve. The rod can have a substantially uniform diameter through its entire length. The center section can be separated from each distal sections of the sleeve by a washer in order to minimize friction between the center section and the distal sections when the massage tool is in use.

Various embodiments of the invention can realize one or more of the following advantages. The devices in accordance with the various embodiments allow not only for compression with the body weight, as is well known in the prior art, but also for cross friction, which can be a very useful type of SMT, and will be described in further detail below.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1A shows a perspective view of a ball designed for SMT, in accordance with one embodiment.

FIG. 1B shows a side view of a ball designed for SMT, in accordance with one embodiment.

FIG. 1C shows a front view of a ball designed for SMT, in accordance with one embodiment.

FIG. 2A shows a picture of the three parts that form the inner core of the ball, in accordance with one embodiment.

FIG. 2B shows a picture of the three parts that form the inner core of the ball, partly assembled, in accordance with one embodiment.

FIG. 2C shows a picture of the inner core of the ball, fully assembled, in accordance with one embodiment.

FIG. 3 shows a perspective view of a rod 300 to be inserted into the ball of FIGS. 1A-C, in accordance with one embodiment

FIG. 4 shows an exploded view of the rod 300, in accordance with one embodiment.

FIG. 5. shows a more detailed view of the rod 300 in FIG. 4, in accordance with one embodiment.

Like reference symbols in the various drawings indicate like elements.

### DETAILED DESCRIPTION

The various embodiments of the invention pertain to devices and techniques for self-myofascial-therapy (SMT). In one embodiment, a ball is provided which is specifically designed for SMT. A user can roll on the ball to create tissue compression, for example, through her body weight. In another embodiment a rod is provided that can be inserted through a hole in the ball. By using the ball and rod together, it is possible for a user to create not only conventional pressure on the tissue, but also to create cross-directional friction into the tissue, as will be described in further detail below.

### The Ball

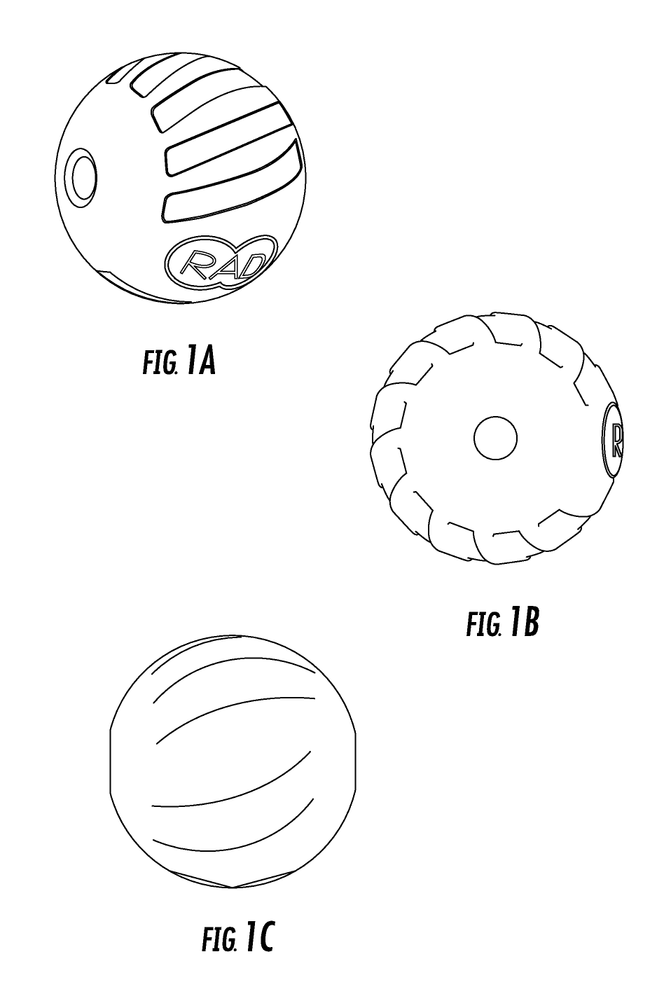

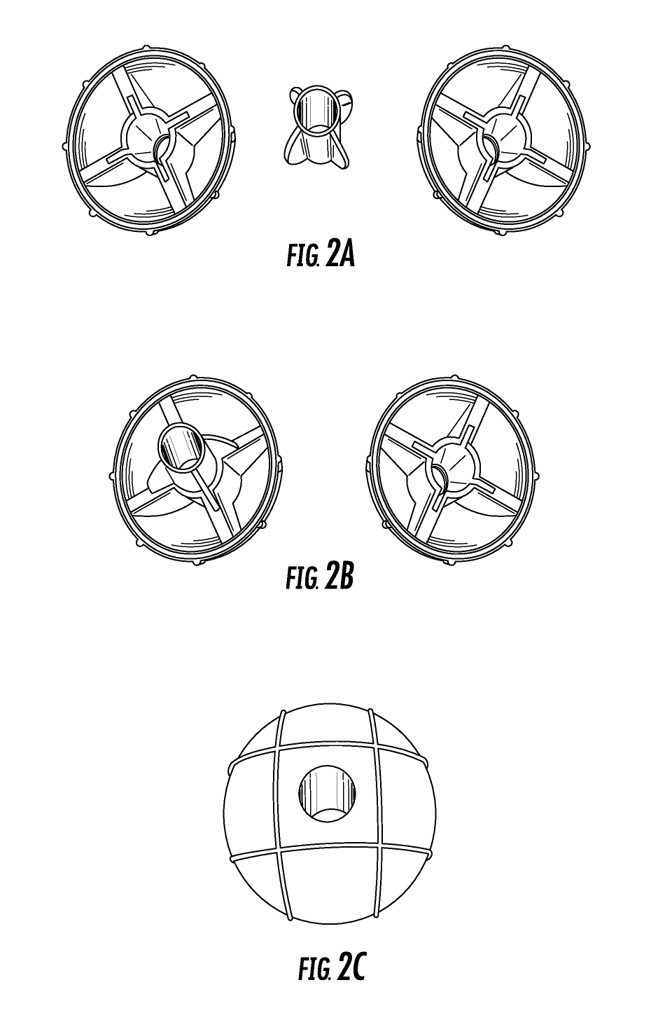

FIGS. 1A-C show different view of a ball designed for SMT in accordance with one embodiment. In the illustrated embodiment, three pieces of a thermoplastic polymer, such as acrylonitrile butadiene styrene (ABS), for example, make up the inner core of the ball. These three pieces are shown in FIG. 2A. FIG. 2B shows the pieces partly assembled, and FIG. 2C shows the inner core in a fully assembled condition. The inner core is covered with an outer layer, which is made from a softer polymer, such as thermoplastic rubber (TPR).

The ABS inner core of the ball enables the rod to rest against a hard interface that does not flex, and keeps structural stability of the ball as a whole when the rod is inserted into the hole through the ball. The ABS core also creates air pockets within the ball, making the ball lighter in order to accommodate ease of travel and portability. The ABS inner core helps the ball maintain its shape and prevent it from deflecting, which is important in order to achieve localized pressure in a precise way when in use.

The outer TPR layer provides a soft interface between the ball and the user's body, so as to not cause discomfort, while at the same time providing sufficient friction against the skin of the user. In one embodiment, the durometer of the outer TPR layer is approximately in the range of 30-35 on the Shore A scale.

In one embodiment, a cylindrical hole extends through the center of the ball, through which hole a rod can be inserted, as can be seen in FIGS. 2A-C. Typically the diameter of the hole is in the range of approximately 0.75-2 inches. While it is preferred that the hole extends through the center of the ball, there may also be embodiments in which the hole is slightly offset and does not pass through the center of the ball. Furthermore, while the preferred shape of the hole is to have a circular cross-section, such that a round rod can be fit into the hole, there may be embodiments in which the hole has a cross-section that is not circular but polygonal, such that a rod with a hexagonal or octagonal cross section, for example, can he fit into the hole.

### The Rod

In one embodiment, the rod (300) is made to fit into the hole of the ball just tightly enough for a user to slide it into the hole with relative ease, but not loosely enough to cause the ball to slide off the rod (300). In order to achieve this, the rod (300) in some embodiments does not have any flanges or other types of protrusions on the handles, which allows the ball to easily slide on to the rod (300).

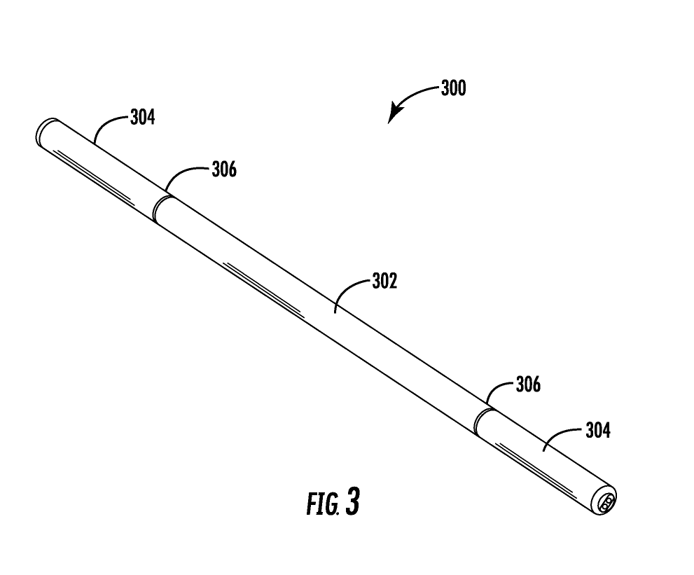

FIG. 3 shows a perspective view of a rod (300) in accordance with one embodiment. As can be seen in FIG. 3, the rod (300) has a center portion (302) and two handles (304). The center portion (302) moves independently from the handles (304) and can roll back and forth along the muscle when the user moves the handles, with or without the ball centered on the rod. In order to reduce the friction between the handles (304) and the center portion (302) of the rod (300), in some embodiments, washers (306) can be provided.

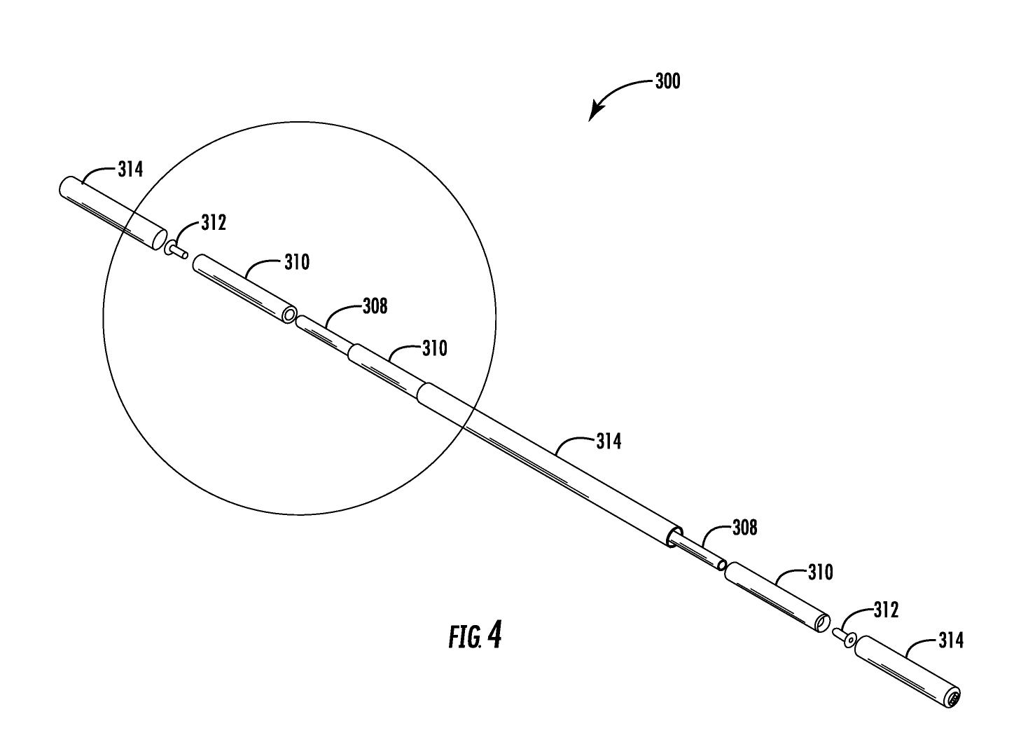

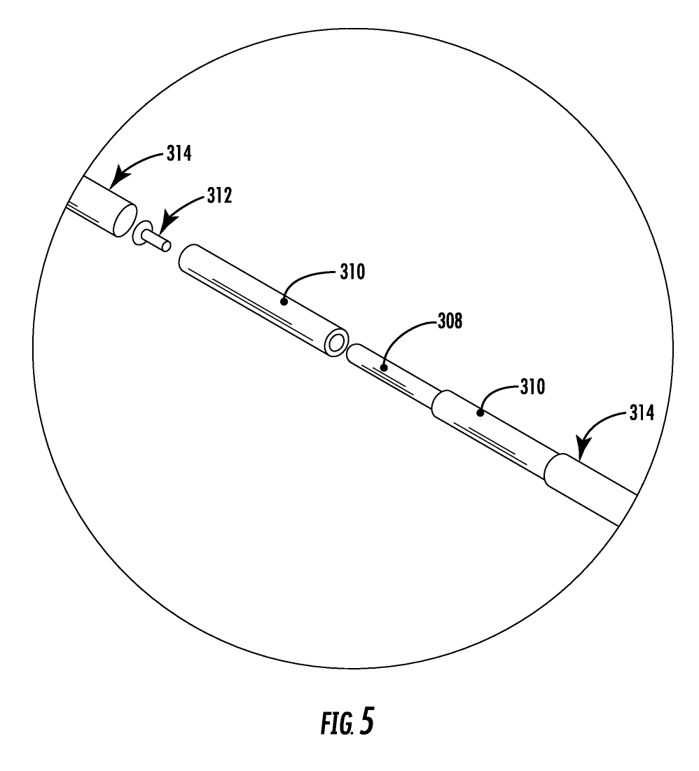

FIG. 4 shows an exploded view of a rod (300) in accordance with one embodiment, and FIG. 5 is a more detailed view of the components shown in the circle of FIG. 4. As can be seen in FIGS. 4 and 5, the rod (300) has a rod (308) at its center. The rod (308) is surrounded by a sleeve (310), which has two distal portions and a central portion, which together have approximately the same length as the rod (308). For ease of illustration, the washers (306) are not illustrated in FIGS. 4 and 5. The three parts of the sleeve (310) are held in place by bolts (312) that are threaded into the rod (308) at its respective ends. A coating (314) is provided on the outside of the different sleeve (310) parts to create a satisfying grip, both for the user's hands, and for holding the ball in place when placed on the rod, and an aesthetically pleasing look for the user.

In one embodiment, the rod (308) is a steel rod and the sleeve (310) is made from Poly Vinyl Chloride (PVC). Having a rod (308) made out of steel creates a low friction surface for the sleeve (310) to roll on. Further it allows for much less flexibility (and thus better massaging properties) compared to conventional rods. In one embodiment, the diameter of the rod (308) is approximately ⅜ inch. This diameter is smaller than conventional rods, thus making for less surface area and more precision and pressure available to a user, in the event that the user wishes to use the rod (300) itself (i.e., without the ball) for SMT purposes.

In one embodiment, the coating (314) on the distal portions of the sleeve (310) is made from silicone and slides over each distal portion of the sleeve (310), where it is held in place through friction. The silicone provides a good grip for the user. The central portion of the sleeve (310) has a thin coating made from Ethylene Vinyl Acetate (EVA) foam, which also stays in place through friction. The EVA foam provides a soft barrier to the hard PVC sleeve (310) below, allowing the user to apply the rod (300) to more sensitive areas of the body, such as the shin, for example. Typically the thickness of the coating (314) of the central portion and the distal portions of the sleeve (310), respectively, are chosen such that the massage rod (300) has a uniform thickness throughout its length. This provides the user with more room to roll compared to conventional designs, which typically have some type of protruding flange separating the central rolling part (302) of the rod (300) from the handles (304).

### Two Exemplary Use Scenarios

When in use, the outside of the ball can be used in the conventional way, that is, simply rolling the ball on the muscle that needs the SMT (i.e., glute, traps, etc.), typically under some amount of pressure exerted by the user's bodyweight.

However, the ball can also be used together with the rod. In this embodiment, the end of the rod inserts through the ball. This allows the user to be able to “crow bar” the tissue or, in more accurate terms, provide cross friction and compression (from just the bodyweight of the user).

For example, imagine a user sitting down on the floor with her legs stretched out in front. She places one end of the rod into the hole of the ball, and then places the ball under her left hamstring, so the rod is sticking out perpendicular to her leg on the left side. If she keeps pressure on the ball with her leg and then moves the other end of the rod upwards towards the midline, this motion causes the ball to rotate sideways, thereby creating the cross-friction on her hamstring.

In another embodiment, the ball can slide further onto the rod such that it is located, for example, close to the center of the rod. This allows the user to hold on to the two handles of the rod and move her arms back and forth in order to roll the ball across the muscles that need to be massaged, while exerting appropriate pressure.

Further, as mentioned above, in one embodiment the rod can work by itself as a myofascial therapy tool for SMT. As the rod has little or no flex during usage and also thin-diameter rolling surface, the surface area of usage is much smaller than conventional handheld massage devices. Therefore, it allows a user to work deeper and more precisely on both small and large muscles. Furthermore, as was described above, the handles are flush with the center sleeve of the rod, making it easy for a user to roll the rod all the way up to the edge of the sleeve without being restricted.

### Alternatives

In some embodiments, there is a clamping mechanism in the center of the ball or on the rod. This allows the ball to slide onto the rod more easily, and then be clamped in place.

The inner core has been described above as being made of separate pieces. However, in some embodiments it can be made of a single piece that is designed and molded differently compared to what is described in the above embodiments.

While the rod and ball have been described above within the context of SMT, it can be used in other ways too, for example, as a so-called “ab-wheel”, which is intended to exercise, among other things, the abdominal muscles of a user.

As to the hardness of the outer TPR layer, it was described above as being approximately in the range of 30-35 on the Shore A scale. However, in other embodiments, it may be higher or lower. Functionally, the device in accordance with these embodiments would perform as well, but it might be less comfortable for the user.

It should be noted that while the ball has been described above as having an ABS internal core, this is not strictly necessary. There may be embodiments that have a different type of core, but they might not work as well, and might be ungainly in its weight. However, the basic function would still be there, albeit in a less user friendly way

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A massage tool for self-myofascial therapy, comprising:
a ball having a hole extending along a chord of the ball,
wherein the hole is adapted for receiving a rod having a diameter that is slightly smaller than the diameter of the hole, so as to provide sufficient friction to hold the rod in place when inserted into the hole,
wherein the ball has an inner core made of a hard thermoplastic polymer, the inner core surrounding the hole, and
wherein the inner core is surrounded by an outer layer made from a softer polymer.

2. The massage tool of claim 1, wherein the chord passes through the center of the ball.

3. The massage tool of claim 1, wherein the softer polymer is thermoplastic rubber.

4. The massage tool of claim 1, wherein the softer polymer has a hardness in the range of approximately 30-35 on the Shore A scale.

5. The massage tool of claim 1, wherein the inner core is made up of three pieces of a hard thermoplastic polymer.

6. The massage tool of claim 1, further comprising a rod inserted into the hole of the ball.

7. The massage tool of claim 6, wherein the rod protrudes on only one side of the ball when inserted into the hole.

8. The massage tool of claim 6, wherein the rod protrudes on both sides of the ball when inserted into the hole.

9. The massage tool of claim 6, wherein the rod comprises a central core surrounded by a sleeve, wherein the sleeve is divided into a center section and two distal sections.

10. The massage tool of claim 9, wherein the distal sections are handles for holding the rod by a user.

11. The massage tool of claim 9, wherein the central core is made from steel.

12. The massage tool of claim 9, wherein the central core has a diameter of approximately ⅜ of an inch.

13. The massage tool of claim 9, wherein the sleeve is made from Polyvinyl Chloride.

14. The massage tool of claim 9, further comprising a coating of silicone on the distal sections of the sleeve.

15. The massage tool of claim 9, further comprising a coating of Ethylene Vinyl Acetate on the central on the center section of the sleeve.

16. The massage tool of claim 6, wherein the rod has a substantially uniform diameter through its entire length.

17. The massage tool of claim 9, wherein the center section is separated from each distal sections of the sleeve by a washer in order to minimize friction between the center section and the distal sections when the massage tool is in use.
